(19) United States
(12) Patent Application Publication
(10) Pub. No.: US 2012/0313985 A1
(43) Pub. Date: Dec. 13, 2012

(54) LIQUID CRYSTAL DISPLAY DEVICE AND LIQUID CRYSTAL DISPLAY METHOD

(75) Inventor: Toshiyuki Gotoh, Osaka-shi (JP)

(73) Assignee: Sharp Kabushiki Kaisha, Osaka-shi ,Osaka (JP)

(21) Appl. No.: 13/579,695

(22) PCT Filed: Dec. 13, 2010
(86) PCT No.: PCT/JP2010/072399

§ 371 Date: Aug. 17, 2012

(30) Foreign Application Priority Data
Mar. 30, 2010 (JP) 2010-079575

(51) Int. Cl. G09G 3/36

(52) U.S. Cl. 345/691; 345/88

(57) ABSTRACT

A liquid crystal display device (101) including a liquid crystal panel (4) and an LED backlight (5) which is provided with a plurality of LEDs (5R, 5G, and 5B) that emit light of different colors from a backside of the liquid crystal panel (4), the liquid crystal display device (1), in accordance with a video signal supplied thereto, (i) displaying a color image by controlling an aperture ratio of the liquid crystal panel (4) and luminances of the respective plurality of LEDs (5R, 5G, and 5B), and (ii) controlling the luminances of the respective plurality of LEDs (5R, 5G, and 5B) by pulse width modulation, the liquid crystal display device (101) includes: period dividing means (15) for dividing a frame of a video signal into a plurality of periods; and a pulse width modulating section (20) which generates a pulse signal for causing each of the plurality of LEDs (5R, 5G, and 5B) to emit light so that for each of the plurality of periods into which the period dividing means (15) has divided the frame, the plurality of LEDs (5R, 5G, and 5B) emit light while overlapping with each other. According to this, a deterioration in display quality is prevented by reducing a variation between a luminance ratio set in accordance with each frame and a luminance ratio of light transmitted through a liquid crystal panel.

### REFERENCE TO RELATED APPLICATIONS

This application is a national stage application under 35 USC 371 of International Application No. PCT/JP2010/072399, filed Dec. 13, 2010, which claims the priority of Japanese Patent Application No. 2010-079575, filed Mar. 30, 2010, the entire contents of which are incorporated herein by reference.

### FIELD OF THE INVENTION

The present invention relates mainly to a liquid crystal display device employing a field sequential method.

### BACKGROUND OF THE INVENTION

In general, many of color display devices such as a television receiver and a computer monitor as an image display device which is capable of color displaying, displays an image by a color mixing method called an additive color mixture, using three primary colors, i.e., red, green and blue.

Currently, a common color display device uses color filters which are colored in R (red), G (green), and B (blue), so as to perform a color display.

Meanwhile, a color display device has been proposed which performs a color display without using such color filters. Such a color display device is exemplified by a color display device employing a field sequential color method which causes red, green, and blue backlights to emit right sequentially.

The color display device employing the field sequential method divides one (1) frame into three sub frames corresponding to R, G, and B and causes the red, green and blue backlights to emit light sequentially, so as to perform a color display.

However, such a color display device causes the following problem: Merely simple division of one (1) frame into three frames corresponding to respective R, G, and B image signals is insufficient for a proper mixture of R, G, and B in one (1) frame depending on an image. This causes color breakup (CB) and consequently causes a deterioration in display quality.

Patent Literature 1 discloses a method for reducing CB (see FIG. 13). According to the method, instead of simply dividing a frame into three sub frames corresponding to respective R, G, and B image signals, one (1) TV field period is divided into three sub fields. In one of the three sub frames, all the G image signals are displayed, whereas as many R and B image signals as possible are displayed. In the other two sub frames, the remaining R and B image signals which have not been displayed in the first sub frame are displayed.

Patent Literature 2 discloses a method for performing a full-color display (see FIG. 14). According to the method, a liquid crystal state is controlled in accordance with a gradation corresponding to each color, i.e., red, green and blue, and a LED (Light Emitting Diode) backlight is subjected to PWM (Pulse Width Modulation) control to emit light while being temporally switched between red, green, and blue. Then, red, blue, and green video images are displayed sequentially, so that these video images are temporally mixed.

According to the method shown in FIG. 14, light emitting luminances of respective three primary colors (R (red), G (green), and B (blue)) of a LED backlight are controlled by controlling light emitting time by PWM control which is high in linearity.

Japanese Patent Application Publication, Tokukai, No. 2009-134156 (Publication Date: Jun. 18, 2009)

Japanese Patent Application Publication, Tokukai, No. 2008-20549 (Publication Date: Jan. 31, 2008)

### SUMMARY OF THE INVENTION

However, a ratio among light emitting luminances of light transmitted through a liquid crystal display is frequently different from a predetermined ratio among three primary colors which is adjusted by PWM control.

FIG. 15 shows that a luminance of light transmitted through a liquid crystal panel varies in accordance with responsiveness of a liquid crystal.

An aperture ratio of a liquid crystal varies even in an identical frame due to responsiveness of a liquid crystal (see FIG. 15). Therefore, even if a LED backlight emits an identical amount of light for an identical period of time, TIMING 1 and TIMING 2 differ in light emitting luminance obtained when light is transmitted through a liquid crystal.

Therefore, in a case where the TIMING 1 and the TIMING 2 differ in light emitting period of each of R, G and, B of the LED backlight and data of each first frame and data of each second frame following the each first frame are different from each other, a ratio among light emitting luminances of the respective colors of the LED backlight is different from a predetermined ratio in each frame (see FIG. 15).

According to the display method disclosed in Patent Literature 1 (see FIG. 13), timings at which a backlight emits light in a frame is specified. In the first sub field, the backlight emits light of the respective colors at different timings, whereas the backlight finishes emitting light of the respective colors at an identical timing. In this case, a difference in aperture ratio of a liquid crystal in a frame may cause a light emitting luminance to be different from a predetermined light emitting luminance.

According to the method disclosed in Patent Literature 2, R, G, and B light sources emit light sequentially in one (1) frame. Therefore, the method cannot solve the problem of CB (described earlier). Namely, in some frames, a problem occurs such that insufficient mixing of R, G, and B causes CB and consequently causes a deterioration in display quality.

The present invention has been made in view of the problems, and an object of the present invention is to prevent a deterioration in display quality by reducing a variation between a luminance ratio which has been set in accordance with each frame and a luminance ratio of light transmitted through a liquid crystal panel.

In order to attain the object, a liquid crystal display device in accordance with the present invention including a liquid crystal panel and a backlight which is provided with a plurality of light sources that emit light of different colors from a backside of the liquid crystal panel, the liquid crystal display device, in accordance with a frame of a video signal supplied thereto, (i) displaying a color image by controlling an aperture ratio of the liquid crystal panel and luminances of the respective plurality of light sources, and (ii) controlling the luminances of the respective plurality of light sources by pulse width modulation, the liquid crystal display device includes period dividing means for dividing a frame of the video signal into a plurality of periods; and a pulse width modulating section which generates a pulse signal for causing each of the plurality of light sources to emit light so that for each of the plurality of periods into which the period dividing means has divided the frame, the plurality of light sources emit light while overlapping with each other.

In order to attain the object, a liquid crystal display method in accordance with the present invention in which in accordance with a video signal supplied to a liquid crystal display device including a liquid crystal panel and a backlight which is provided with a plurality of light sources that emit light of different colors from a backside of the liquid crystal panel, (i) a color image is displayed by controlling an aperture ratio of the liquid crystal panel and luminances of the respective plurality of light sources, and (ii) the luminances of the respective plurality of light sources are controlled by pulse width modulation, the liquid crystal display method includes the steps of: (a) dividing a frame of the video signal into a plurality of periods; and (b) generating a pulse signal for causing each of the plurality of light sources to emit light so that for each of the plurality of periods into which the frame has been divided in the step (a), the plurality of light sources emit light while overlapping with each other.

According to the arrangement mentioned above, the period dividing means divides a frame into a plurality of periods. The pulse width modulating section generates a pulse signal for causing each of the plurality of light sources to emit light for each of the periods into which the frame has been divided by the dividing means. As described earlier, even if an aperture ratio of the liquid crystal panel varies in the frame, division, into a plurality of periods, of a period in which a light source emits light in one (1) frame can reduce a variation between (i) a ratio (predetermined luminance ratio) among luminances (predetermined luminances) of respective light sources for displaying a color image and (ii) a ratio (transmission luminance ratio) among luminances (transmission luminances) of respective light sources which have been actually transmitted through the liquid crystal panel.

According to the arrangement mentioned above, the pulse width modulating section generates a pulse signal for causing each of the plurality of light sources to emit light so that for each of the plurality of periods into which the period dividing means has divided the frame, the plurality of light sources emit light while overlapping with each other. According to this, colors of light emitted from the respective plurality of light sources are mixed for each of the plurality of periods of the frame. Therefore, even if an aperture ratio of the liquid crystal panel varies in the frame, a variation between a predetermined luminance ratio and transmission luminance ratio can be reduced.

Furthermore, according to the arrangement mentioned above, colors of light emitted from the respective light sources are mixed for each of the plurality of periods of the frame. Therefore, a variation between a predetermined luminance ratio and a transmission luminance ratio can be reduced also in a different frame.

As described earlier, the arrangement mentioned above allows a reduction in variation between a predetermined luminance ratio and a transmission luminance ratio, so that a deterioration in display quality can be prevented.

A liquid crystal display device in accordance with the present invention including a liquid crystal panel and a backlight which is provided with a plurality of light sources that emit light of different colors from a backside of the liquid crystal panel, the liquid crystal display device, in accordance with a video signal supplied thereto, (i) displaying a color image by controlling an aperture ratio of the liquid crystal panel and luminances of the respective plurality of light sources, and (ii) controlling the luminances of the respective plurality of light sources by pulse width modulation, the liquid crystal display device includes period dividing means for dividing a frame of the video signal into a plurality of periods; and a pulse width modulating section which generates a pulse signal for causing each of the plurality of light sources to emit light so that for each of the plurality of periods into which the period dividing means has divided the frame, the plurality of light sources emit light while overlapping with each other.

A liquid crystal display method in accordance with the present invention in which in accordance with a video signal supplied to a liquid crystal display device including a liquid crystal panel and a backlight which is provided with a plurality of light sources that emit light of different colors from a backside of the liquid crystal panel, (i) a color image is displayed by controlling an aperture ratio of the liquid crystal panel and luminances of the respective plurality of light sources, and (ii) the luminances of the respective plurality of light sources are controlled by pulse width modulation, the liquid crystal display method includes the steps of: (a) dividing a frame of the video signal into a plurality of periods; and (b) generating a pulse signal for causing each of the plurality of light sources to emit light so that for each of the plurality of periods into which the frame has been divided in the step (a), the plurality of light sources emit light while overlapping with each other.

This yields an effect of preventing a deterioration in display quality by reducing a variation between a luminance ratio set in accordance with a frame and a luminance ratio of light transmitted through a liquid crystal panel.

### BRIEF DESCRIPTION OF THE DRAWINGS

FIG. 1 is a block diagram showing an arrangement of a liquid crystal display device of the present invention.

FIG. 2 is a block diagram showing an arrangement of a LED driver control section and a pulse width modulating section of the liquid crystal display device of the present invention.

FIG. 3 explains each pulse signal of one (1) sub frame.

FIG. 4 shows how PWM signals are generated at respective duties of 100%, 50%, and 25%.

FIG. 5 shows how PWM signals at respective duties of 100%, 50%, and 25% are generated in a case where High is set to be outputted at the beginning of each sub period.

FIG. 6 shows how PWM signals at respective duties of 100%, 50%, and 25% are generated in a case where High is set to be outputted at the end of each sub period.

(a) of FIG. 7 shows how LEDs R, G, and B are sequentially turned on by causing the LEDs R, G, and B to turn off at an identical timing without dividing one (1) sub frame into a plurality of periods. (b) of FIG. 7 shows transmission luminances of light which has been transmitted through the LCD in accordance with the method shown in (a) of FIG. 7.

(a) of FIG. 8 shows how the LEDs R, G, and B are sequentially turned on by causing the LEDs R, G, and B to start turning on at an identical timing without dividing one (1) sub frame into a plurality of periods. (b) of FIG. 8 shows transmission luminances of light which has been transmitted through the LCD in accordance with the method shown in (a) of FIG. 8.

(a) of FIG. 9 shows how the LEDs R, G, and B are sequentially turned on by causing centers of respective turn-on periods of the respective LEDs R, G, and B to coincide with each other without dividing one (1) sub frame into a plurality of periods. (b) of FIG. 9 shows transmission luminances of light which has been transmitted through the LCD in accordance with the method shown in (a) of FIG. 9.

(a) of FIG. 10 shows a method of turning on the LEDs R, G, and B for each of a plurality of periods into which one (1) sub frame has been divided. (b) of FIG. 10 shows transmission luminances of light which has been transmitted through the LCD in accordance with the method shown in (a) of FIG. 10.

FIG. 11 is a flowchart showing how a process is carried out in a liquid crystal display device of the present invention.

FIG. 12 is a block diagram showing an arrangement of LED driver control section and another pulse width modulating section.

FIG. 13 shows how an image is displayed by a conventional field sequential method.

FIG. 14 shows how an image is displayed by another conventional field sequential method.

FIG. 15 shows that a luminance of light transmitted through a liquid crystal panel varies in accordance with responsiveness of a liquid crystal.

### DETAILED DESCRIPTION OF THE INVENTION

An embodiment of the present invention is specifically described below.

<Overall view of Liquid Crystal Display Device>

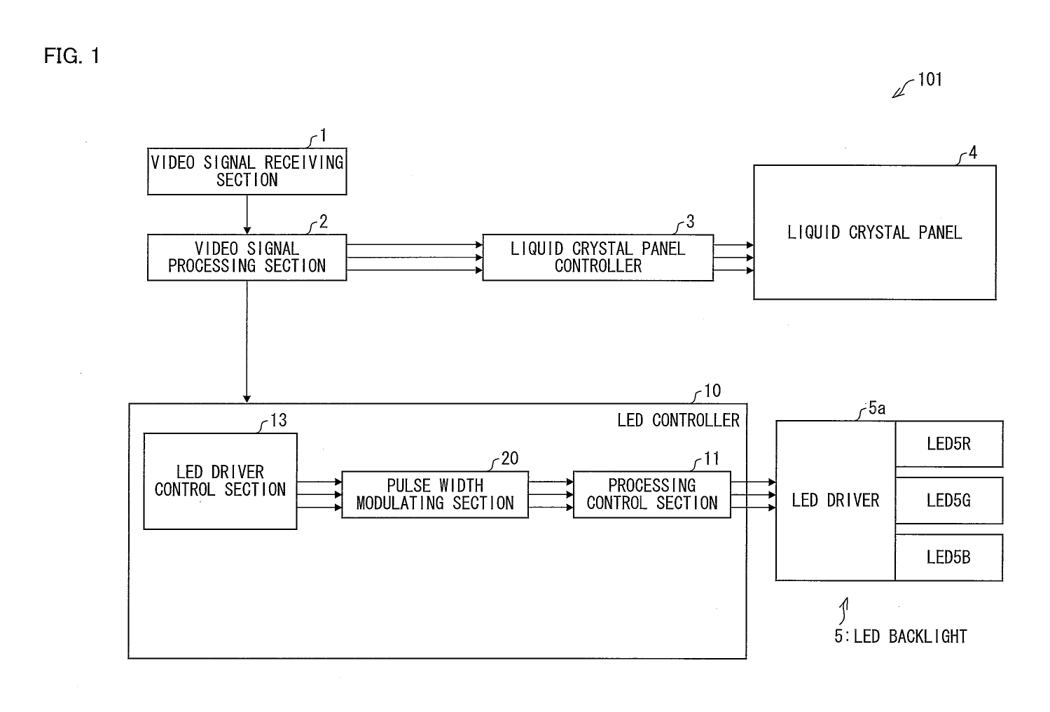

FIG. 1 is a block diagram showing an arrangement of the liquid crystal display device 101 of the present invention.

The liquid crystal display device 101 includes a video signal receiving section 1, a video signal processing section 2, a liquid crystal panel controller 3, a liquid crystal panel 4, an LED controller 10, and an LED backlight (Backlight) 5 (see FIG. 1). The LED controller 10 includes a process control section 11, a pulse width modulating section 20, and an LED driver control section (period dividing means) 13.

The liquid crystal panel 4 is a liquid crystal panel which includes no color filter.

The LED backlight 5 includes an LED (light source) 5R which emits red light as a first color, an LED (light source) 5G which emits green light as a second color, and an LED (light source) 5B which emits blue light as a third color. The LED backlight 5 further includes an LED driver 5a which controls driving of each of the LED 5R, the LED 5G, and the LED 5B. A plurality of LEDs 5R, a plurality of LEDs 5G, and a plurality of LEDs 5B are provided in a planar pattern.

The liquid crystal display device 101 not only performs a color display by a field sequential method but also controls a backlight for each display area (carries out area active drive control). Therefore, a ferroelectric liquid crystal which is suitable for a field sequential method and whose response speed is high is used for the liquid crystal panel 4, and a backlight which uses an LED (Light Emitting Diode) serving as a light emitting device is used the LED backlight 5.

The video signal receiving section 1 receives and processes an externally inputted video signal. From an antenna or the like (not illustrated), the video signal receiving section 1 receives, as a video signal, a composite video signal which contains, for example, a color signal indicative of a display color of a display image, a luminance signal indicative of a luminance for each pixel, and a sync signal. Then, the video signal receiving section 1 supplies the composite video signal thus received to the video signal processing section 2.

The video signal processing section 2 separates the composite video signal into data for the liquid crystal panel 4 and data for causing the LED backlight 5 to turn on. In accordance with the composite video signal supplied from the video signal receiving section 1, the video signal processing section 2 generates an RGB data signal indicative of R, G, and B display tone values and sync signals (a sync clock CLK, a horizontal sync signal HS, and a vertical sync signal VS).

The video signal processing section 2 further divides one (1) frame into a plurality of sub frames, so as to generate a plurality of sub frames. For example, in a case where one (1) frame is a period of 60 Hz and the one (1) frame is divided into four sub frames, each of the four sub frames is a period of 240 Hz.

As described earlier, the video signal processing section 2 divides one (1) frame into a plurality of sub frames, and causes the liquid crystal panel 4 to display an image by the plurality of sub frames obtained by the division. Then, the LED controller 10 sequentially turns on three primary colors of LEDs 5R, 5G, and 5B at a suitable luminance for each of the plurality of sub frames into which the video signal processing section 2 has divided one (1) frame (described later). This enables the liquid crystal display device 101 to consume less electric power.

For each of the plurality of sub frames, the video signal processing section 2 generates an RGB data signal and a sync signal for the liquid crystal panel 4, and an RGB data signal and a sync signal for turning on the LED backlight 5. The video signal processing section 2 supplies, to the liquid crystal panel controller 3, the RGB data signal and the sync signal for the liquid crystal panel 4. The video signal processing section 2 also supplies, to the LED controller 10, the RGB data signal and the sync signal for turning on the LED backlight 5.

The liquid crystal panel controller 3 finds an aperture ratio of a liquid crystal (LCD aperture ratio) in accordance with the RGB data signal and the sync signal for the liquid crystal panel 4 which have been supplied from the video signal processing section 2. Then, the liquid crystal panel controller 3 supplies, to a source driver (not illustrated) and a gate driver (not illustrated) of the liquid crystal panel 4, an instruction signal for driving the liquid crystal panel 4. This causes the liquid crystal panel 4 to be subjected to control of an aperture ratio for each sub frame.

In accordance with the RGB data signal and the sync signal for turning on the LED backlight 5 which have been supplied from the video signal processing section 2 to the LED controller 10, the LED driver control section 13 generates, for each sub frame, PWM values which serve as signals for controlling pulse widths of the respective LEDs 5R, 5G, and 5B, and a clock signal GsClk. The LED driver control section 13 supplies the PWM values and the clock signal to the pulse width modulating section 20.

A PWM value refers to a duty of each of the LED 5R, the LED 5G, and the LED 5B in a plurality of periods into which one (1) sub frame has been further divided. A clock signal GsClk refers to a clock signal which is outputted at a frequency obtained by multiplying, by a frequency of one (1) sub frame, the number of the plurality of periods into which one (1) sub frame has been further divided. An arrangement of the LED driver control section 13 is described later.

The pulse width modulating section 20 generates a pulse signal for causing each of the LED 5R, the LED 5G and the LED 5B to emit light so that for each of the plurality of periods into which the LED driver control section 13 has divided the sub frame, the LED 5R, the LED 5G, and the LED 5B emit light while overlapping with each other.

The pulse width modulating section 20 generates a PWM R signal, a PWM G signal, and a PWM B signal in accordance with (i) the clock signal GsClk which has been supplied from a clock oscillating section 17 and serves as a PWM modulating signal for each color and (ii) the PWM values of the LED 5R, the LED 5G, and the LED 5B, respectively, which have been supplied from the LED driver control section 13. The PWM R signal, the PWM G signal, and the PWM B signal are PWM signals for the LED 5R, the LED 5G, and the LED 5B, respectively, for each sub frame. Then, the pulse width modulating section 20 supplies the PWM R signal, the PWM G signal, and the PWM B signal to the process control section 11. The pulse width modulating section 20 is described later.

The process control section 11 is an interface for the LED backlight 5. The process control section 11 converts the PWM R signal, the PWM G signal, and the PWM B signal from the pulse width modulating section 20 into respective signals for turning on the back light 5 and supplies the signals to the LED driver 5a, so as to control turning-on of each of the LED 5R, the LED 5G, and the LED 5B.

As described earlier, the liquid crystal display 101 carries out area active drive with respect to the LED backlight 5 in accordance with a video signal to be displayed in the liquid crystal panel 4.

<Description of LED Driver Control Section 13 and Pulse Width Modulating Section 20>

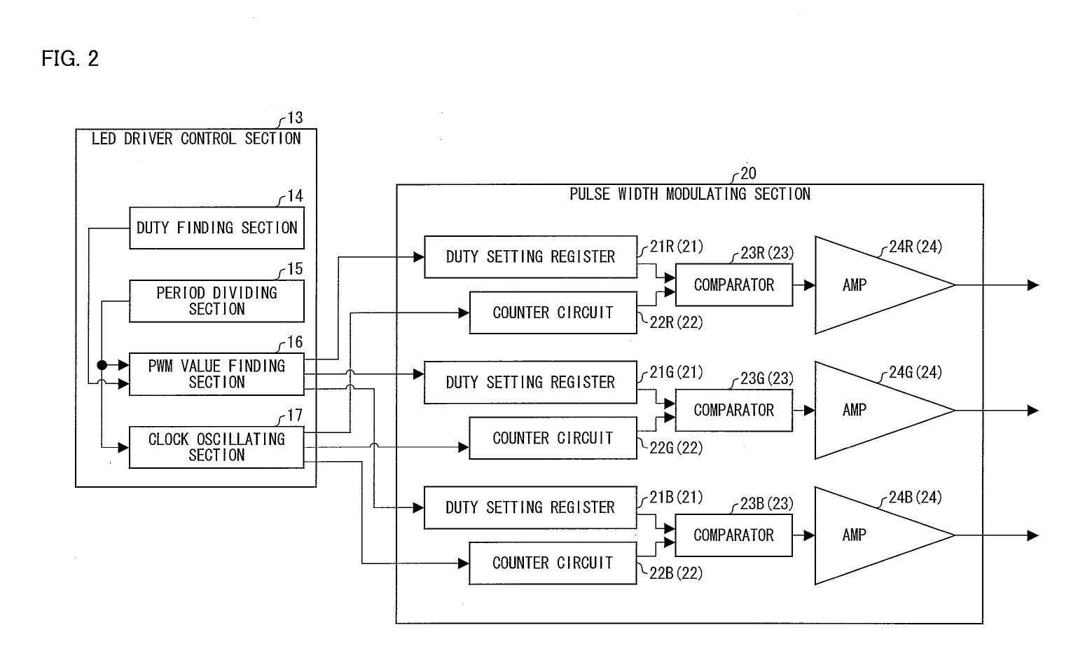

Next, the following description specifically discusses the LED driver control section 13 and the pulse width modulating section 20 with reference to FIG. 2.

FIG. 2 is a block diagram showing an arrangement of the LED drive control section 13 and the pulse width modulating section 20.

The LED driver control section 13 includes a duty finding section 14, a period dividing section (period dividing means) 15, a PWM value finding section 16, and the clock oscillating section 17.

The pulse width modulating section 20 includes, for each color, a duty setting register 21, a counter circuit 22, a comparator 23, and AMP 24.

In other words, the duty setting register 21 consists of a duty setting register 21R for controlling the LED 5R, a duty setting register 21G for controlling the LED 5G, and a duty setting register 21B for controlling the LED 5B. Same applies to the counter circuit 22, the comparator 23, and the AMP 24. The counter circuit 22 consists of counter circuits 22R, 22G, and 22B for controlling the LED 5R, the LED 5G, and the LED 5B, respectively. The comparator 23 consists of 23R, 23G, and 23B for controlling the LED 5R, the LED 5G, and the LED 5B, respectively. The AMP 24 consists of AMPs 24R, 24G, and 24B for controlling the LED 5R, the LED 5G, and the LED 5B, respectively. Note that it is only necessary to provide the AMPs 24R, 24G, and 24B according to need and provision of the AMPs 24R, 24G, and 24B may be omitted.

In accordance with the RGB data signal and the sync signal for turning on the LED backlight 5, the RGB data signal and the sync signal each having been supplied from the video signal processing section 2 to the LED controller 10, the duty finding section 14 finds, for each sub frame, duties (Duty: light emitting ratio) of the respective LEDs 5R, 5G, and 5B for carrying out area active drive with respect to the LED backlight 5. The duty finding section 14 supplies, to the PWM value finding section 16, the duties of the respective LEDs 5R, 5G, and 5B which duties have been found for the each sub frame.

The period dividing section 15 further divides one (1) sub frame equally into a plurality of periods (e.g. four periods) in accordance with the RGB data signal and the sync signal for turning on the LED backlight 5, the RGB data signal and the sync signal each having been supplied from the video signal processing section 2 to the LED controller 10.

Note that it is only necessary to divide one (1) sub frame into two periods or more. In addition, the present invention can yield more effects as a plurality of periods into which one (1) sub frame is divided increase in number. However, this requires a faster processing speed as hardware.

Further, the number of periods into which one (1) sub frame is divided may be preliminarily set, for example, at the time of factory shipment, to be a given number or to be changed in accordance with a duty of one (1) sub frame. In addition, the number of periods into which one (1) sub frame is divided may be fixed for each color or may be changed for each color.

The periods dividing section 15 supplies, to each of the PWM value finding section 16 and the clock oscillating section 17, the number (division number) of periods into which one (1) sub frame is divided.

In accordance with (i) the duties of the respective LEDs 5R, 5G, and 5B for each sub frame, the duties having been supplied from the duty finding section 14 and (ii) the division number of one (1) sub frame, the division number having been supplied from the period dividing section 15, the PWM value finding section 16 assigns the duties of the respective LEDs 5R, 5G, and 5B to each of periods obtained by the division by the period dividing section 15. Then, the PWM value finding section 16 supplies, to the duty setting register 21 (duty setting registers 21R, 21G, and 21B), the duties of the respective LEDs 5R, 5G, and 5B assigned to the each of the periods as PWM values (e.g., ranging from 0 to 4095).

The clock oscillating section 17 outputs a clock signal of a given period. To the counter circuit 22 (counter circuits 22R, 22G, and 22B), the clock oscillating section 17 supplies, as the clock signal GsClk, a clock signal at a frequency obtained by multiplying a predetermined frequency of one (1) sub frame (e.g., 240 Hz) by a division number of one (1) sub frame, the division number having been supplied from the period dividing section 15.

The duty setting register 21 (21R, 21G, and 21B) instructs the comparator 23 of a timing at which a PWM signal outputs High or Low. At a given timing, the duty setting register 21 which has obtained a PWM value supplied from the PWM value finding section 16 supplies, to the comparator 23 (comparators 23R, 23G and 23B), a High/Low instruction signal indicative of an instruction to cause the PWM signal to output High or Low for each PWM value.

As for a timing at which the duty setting register 21 supplies the High/Low instruction signal to the comparator 23, the duty setting register 21 may supply the High/Low instruction signal to the comparator 23 at the beginning of one (1) sub frame at one time. Alternatively, the duty setting register 21 may supply the High/Low instruction signal for each of the periods.

The counter circuit 22 (counter circuits 22R, 22G, and 22B) counts pulses of the clock GsClk supplied from the clock oscillating section 17, and supplies the number of counts to the comparator 23 (comparators 23R, 23G and 23B).

The comparator 23 receives (i) the High/Low instruction signal indicative of an instruction to cause the PWM signal to output High or a Low for each PWM value, the High/Low instruction signal having been supplied from the duty setting register 21, and (ii) the number of counts which has been supplied from the counter circuit 22. When the number of counts which has been supplied from the counter circuits 22 reaches a value indicated by the High/Low instruction signal which has been supplied from the duty setting register 21, the comparator 23 supplies, to the AMP 24 (AMPs 24R, 24G and 24B), a High/Low PWM signal for causing the LED 5R, the LED 5G, and the LED 5B to turn on (be ON) or turn off (be OFF).

The AMP 24 amplifies the High/Low PWM signal supplied from the comparator 23, and supplies the High/Low PWM signal to the LED backlight 5 via the process control section 11 at a subsequent stage.

This allows control of a timing at which the LED 5R, the LED 5G, and the LED 5B turn on/off.

As described earlier, according to the liquid crystal display device 101, since an image display is performed by the field sequential method, it is unnecessary that the liquid crystal panel 4 include a color filter. This increases a transmittance of the liquid crystal panel 4. In addition, the LED backlight 5 which sequentially turns on three primary colors (R, G and B) at a suitable luminance for each of the plurality of sub fields enables the liquid crystal display device 101 to consume less electric power. The liquid crystal display device 101 is arranged such that a plurality of sub frames into which one (1) frame has been divided are further divided into a plurality of periods. The pulse width modulating section 20 modulates a pulse width so that R, G, and B emit light while overlapping with each other for each of the plurality of periods. This enables suitable luminance control for each of the plurality of sub frames.

Furthermore, the pulse width modulating section 20, which includes a plurality of stages of circuits for the respective colors, is capable of carrying out pulse with modulating processes for the respective LEDs 5R, 5G, and 5B simultaneously. This allows pulse width modulation to be carried out with respect to the LEDs 5R, 5G, and 5B in a shorter time.

The above description discusses the pulse width modulating section 20 assuming that the pulse width modulating section 20 includes a plurality of sets of circuits for the respective colors. Alternatively, the pulse width modulating section 20 may include only single-set circuits as shown in a pulse with modulating section 20a (see FIG. 12).

FIG. 12 is a block diagram showing an arrangement of the LED driver control section 13 and another pulse width modulating section 20a.

The pulse width modulating section 20a includes a duty setting register 21a, a counter circuit 22a, a comparator 23a, and an AMP 24a.

As described earlier, the pulse width modulating section 20a may include single-set circuits. In this case, since the pulse width modulating section 20a includes single-set circuits, a process for controlling each of the LEDs (LED 5R, LED 5G, and LED 5B) to turn on is carried out sequentially for each color for each sub frame.

The pulse width modulating section 20a which is thus arranged to include single-set circuits enables a reduction in cost as compared with the pulse width modulating section 20 including a plurality of sets of circuits.

<Pulse Width Modulation>

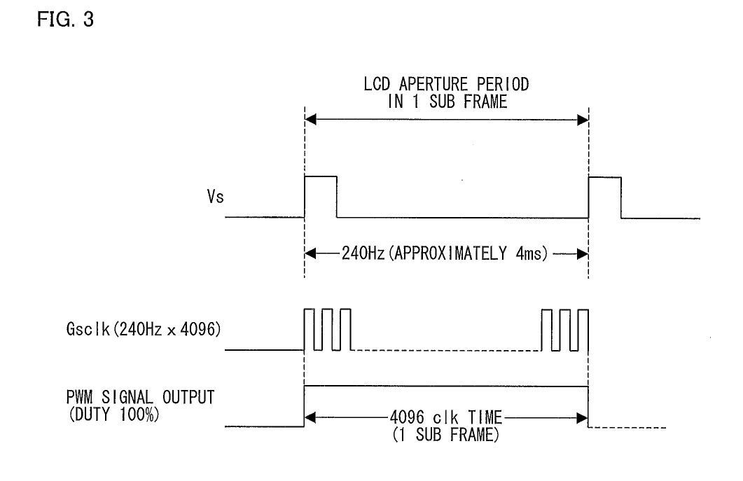

Next, the following description discusses pulse width modulation with reference to FIGS. 3 to 6.

Firstly, a case where one (1) sub frame is not divided into a plurality of periods is discussed with reference to FIG. 3.

FIG. 3 shows each pulse signal of one (1) sub frame.

Assume that a clock interval of a vertical sync period Vs (an aperture period of an LCD in one (1) sub frame) is 240 Hz (approximately 4 ms). In this case, a clock interval of the clock signal GsClk, which is supplied from the clock oscillating section 17 to the counter circuit 22, is also set to be 240 Hz (approximately 4 ms) in accordance with the clock interval of the vertical sync period Vs.

In a case where light control is carried out in one (1) sub frame, a duty is set to be 100% by counting 4096 clocks of the clock signal GsClk at the interval of 240 Hz (approximately 4 ms).

Namely, in a case where one (1) sub frame is not divided into a plurality of periods, e.g., in a case where the LED 5G emits light at a duty of 100%, the PWM value finding section 16 supplies 4096, which is the number of counts of one (1) sub frame, to the duty setting register 21G as a PWM value.

The duty setting register 21G which has obtained the PWM value indicative of 4096 from the PWM value finding section 16 supplies, to the comparator 23G, a signal for outputting High at the first count and outputting Low at the 4096th count.

The comparator 23G which has obtained the first count of the counts supplied from the counter circuit 22G outputs High as a PWM signal (PWM G signal) output. The comparator 23G which has obtained the 4096th count from the counter circuit 22G outputs Low as a PWM signal (PWM G signal) output. The comparator 23G thus supplies, to the AMP 24G, a PWM signal (PWM G signal) as a signal at a duty of 100%. The AMP 24G amplifies the PWM signal (PWM G signal) supplied thereto. The PWM signal thus amplified is supplied to the LED 5G via the process control section 11 and the LED driver 5a, so that the LED 5G is controlled to turn on/off.

According to this, in order to cause each of the LEDs 5R, 5G, and 5B to emit light at a duty of 100% (in one (1) sub frame), it is necessary that a frequency (period) between when the comparator 23 outputs High and when the comparator 23 outputs Low be 240 (Hz)×4096 (counts)=983040 (Hz), which is approximately 1 MHz.

Similarly, for example, in order to cause a duty to be 10% in one (1) sub frame, it is only necessary that, when the counter circuit 22 finishes counting 409 clocks of the clock signal GsClk, the comparator 23 causes an output of the PWM signal to switch from High to Low.

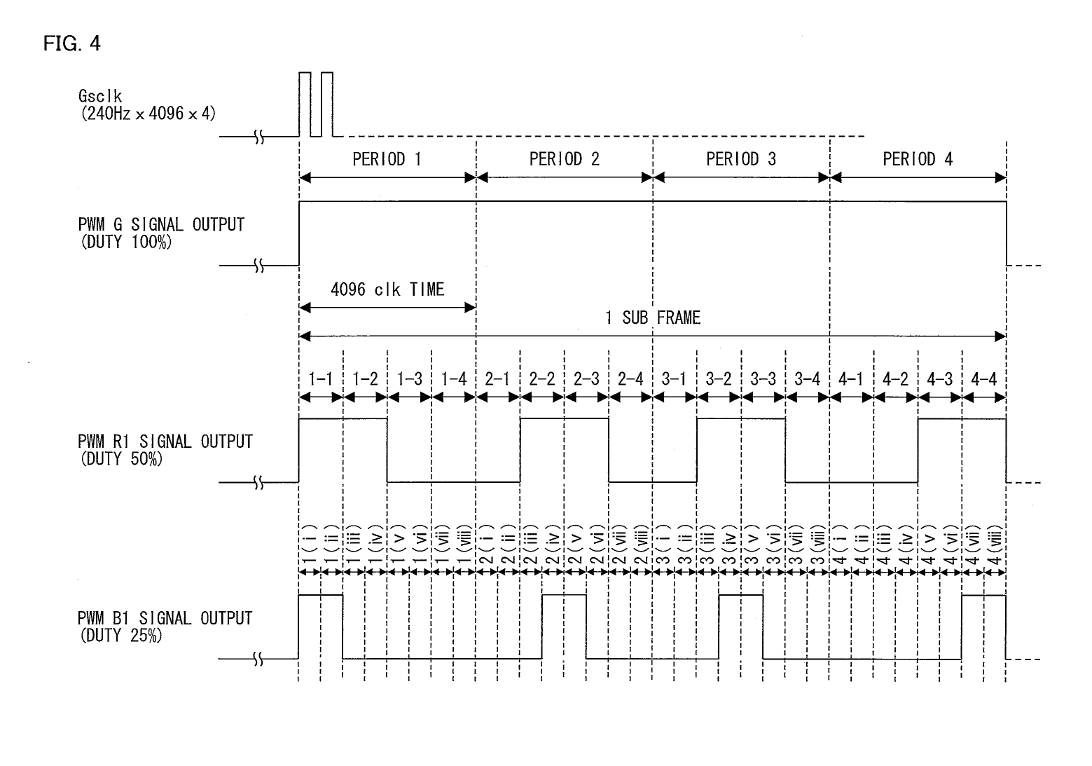

Next, the following description discusses, with reference to FIGS. 4 to 6, how PWM signals are generated in a case where one (1) sub frame is divided into a plurality of periods.

FIG. 4 shows how PWM signals are generated which have respective duties of 100%, 50%, and 25%.

According to the present invention, one (1) sub frame is further divided into a plurality of periods in each of which the number of clocks of the clock signal GsClk is counted, so that duties of the respective LEDs 5R, 5G, and 5B are controlled (see FIG. 4). According to the present embodiment, one (1) sub frame is divided into four periods.

A first period of the four periods into which one (1) sub frame is divided is set to be a period 1. A period following the period 1 is set to be a period 2. A period following the period 2 is set to be a period 3. A period following the period 3 is set to be a period 4 (see FIG. 4).

Since one (1) sub frame is divided into four periods, a clock frequency of the clock signal GsClk for counting one (1) period is 240 (Hz)×4096 (counts)×4=3932160 (Hz), which is approximately 4 MHz.

That is, when one (1) sub frame is divided into four periods, a clock frequency of the clock signal GsClk also quadruples. As described earlier, a clock frequency of the clock signal GsClk is obtained by multiplying, by the number of periods into which one (1) sub frame is divided, a clock frequency obtained when one (1) sub frame is not divided.

Note that a major difference between a method for generating a PWM signal when one (1) sub frame is not divided (described with reference to FIG. 3) and a method for generating a PWM signal when one (1) sub frame is divided (see FIG. 4) is a clock frequency of the clock signal GsClk. Therefore, hardware of the pulse width modulating section 20 can have an identical arrangement in both the methods.

The period 1 is a period between the first count and the 4096th count. The period 2 is a period between the 4097th count and the 8192th (4096×2) count. The period 3 is a period between the 8193th count and the 12288 (4093×3) count. The period 4 is a period between the 12289th count and the 16384th (4096×4) count.

A PWM G signal output shows a state of an output of a PWM signal, the output being supplied from the comparator 23G to the LED 5G, and shows a state of an output of the PWM signal in a case where the LED 5G turns on at a duty of 100% in one (1) sub frame. Among PWM G signal outputs, a High output causes the LED 5G to turn on, and a Low output causes the LED 5G to turn off.

A PWM R1 signal output shows a state of an output of a PWM signal, the output being supplied from the comparator 23R to the LED 5R, and shows a state of an output of the PWM signal in a case where the LED 5R turns on at a duty of 50% in one (1) sub frame. Among PWM R1 signal outputs, a High output causes the LED 5R to turn on, and a Low output causes the LED 5R to turn off.

A PWM B1 signal output shows a state of an output of a PWM signal, the output being supplied from the comparator 23B to the LED 5B, and shows a state of an output of the PWM signal in a case where the LED 5B turns on at a duty of 25% in one (1) sub frame. Among PWM B1 signal outputs, a High output causes the LED 5B to turn on, and a Low output causes the LED 5B to turn off.

Duties of the respective LEDs 5G, 5R, and 5B in each of the periods 1 to 4 into which one (1) sub frame is divided are duties of the respective LEDs 5G, 5R, and 5B which are assigned to the one (1) sub frame.

As shown in the PWM G signal output, in a case where a duty is 100%, the comparator 23G outputs High from the beginning of one (1) sub frame (the first count). Then, the comparator 23G outputs Low at the end of the one (1) sub frame (4096×4th count).

The PWM R1 signal output shows a PWM signal output at a duty of 50%. Therefore, 50% of the PWM R1 signal output is High in each of the periods 1 to 4. That is, in each of the periods 1 to 4, High is outputted for a period equivalent to 4096×0.5=2048 counts.

For the PWM R1 signal output, the period dividing section 15 further divides each of the periods 1 to 4 into four sub periods.

Four sub periods, into which the period 1 has been divided, from the first sub period to the last sub period, are set to be a sub period 1-1, a sub period 1-2, a sub period 1-3, and a sub period 1-4, respectively. Four sub periods, into which the period 2 has been divided, from the first sub period to the last sub period, are set to be a sub period 2-1, a sub period 2-2, a sub period 2-3, and a sub period 2-4, respectively. Four sub periods, into which the period 3 has been divided, from the first sub period to the last sub period, are set to be a sub period 3-1, a sub period 3-2, a sub period 3-3, and a sub period 3-4, respectively. Four sub periods, into which the period 4 has been divided, from the first sub period to the last sub period, are set to be a sub period 4-1, a sub period 4-2, a sub period 4-3, and a sub period 4-4, respectively.

In the period 1, the duty setting register 21R supplies, to the comparator 23R, a High instruction signal at the first count and a Low instruction signal at the end of the sub period 1-2. Namely, in the period 1, the comparator 23R outputs High from the beginning of the sub period 1-1 (i.e., the beginning of one (1) sub frame), and the counter circuit 22R counts the number of clocks of the clock signal GsClk and supplies the counted number of clocks to the comparator 23R. The comparator 23R obtains the counted number of clocks from the counter circuit 22R, and outputs Low after obtaining 2048 ((4096/4)×2) counts.

According to this, in the period 1, the PWM R1 signal outputs High in the sub periods 1-1 and 1-2, which are the first two sub periods of the period 1, whereas the PWM R1 signal outputs Low in the periods 1-3 and 1-4, which are the latter two sub periods.

In the period 2, the duty setting register 21R supplies, to the comparator 23R, a High/Low instruction signal which is later than that in the period 1 by one (1) sub period (a period equivalent to the sub period 2-1). Therefore, the comparator 23R outputs High after the counter circuit 22R counts {(4096/2)−(2048/2)}=1024 clocks from the beginning of the period 2.

That is, in the period 2, the duty setting register 21R supplies, to the comparator 23R, a High instruction signal at the end of the sub period 2-1 and a Low instruction signal at the end of the sub period 2-3. The comparator 23R obtains the counted number of clocks from the counter circuit 22R. The comparator 23R outputs High after obtaining (4096+(4096/4))=5121 counts, and outputs Low after obtaining (4096+(4096/4)×3)=7168 counts.

As described earlier, in the period 2, the PWM R1 signal outputs (i) Low in the sub periods 2-1 and 2-4, which are the respective first and last sub periods, and (ii) High in the sub periods 2-2 and 2-3, which are the respective middle two sub periods.

In the period 3, as in the case of the period 2, the duty setting register 21R supplies, to the comparator 23R, a High/Low instruction signal which is later than that in the period 1 by one (1) sub period (a period equivalent to the sub period 3-1). Therefore, the comparator 23R outputs High after the counter circuit 22R counts {(4096/2)−(2048/2)}=1024 clocks from the beginning of the period 3.

Namely, in the period 3, the duty setting register 21R supplies, to the comparator 23R, a High instruction signal at the end of the sub period 3-1 and a Low instruction signal at the end of the sub period 3-3. The comparator 23R obtains the counted number of clocks from the counter circuit 22R. The comparator 23R outputs High after obtaining {(4096×2)+(4096/4)}=9216 counts, and outputs Low after obtaining {(4096×2)+(4096/4)×3}=11264 counts.

As described earlier, in the period 3, the PWM R1 signal outputs (i) Low in the sub periods 3-1 and 3-4, which are the respective first and last sub periods, and (ii) High in the sub periods 3-2 and 3-3, which are the respective middle two sub periods.

In the period 4, it is only necessary that the LED 5R turn off (Low be outputted) for a period equivalent to the number of clocks (2048) which is obtained by subtracting a light emitting period (a period of a High output) from the number of clocks in the period 4 (4096), and then the LED 5R turn on (High be outputted) for a period equivalent to the given number of clocks.

That is, in the period 4, the duty setting register 21R supplies, to the comparator 23R, a High/Low instruction signal which is later than that in the period 1 by two sub periods (periods equivalent to the sub periods 4-1 and 4-2). Therefore, the comparator 23R outputs High after the counter circuit 22R counts {(4096/2)−(2048/2)}×2=2048 clocks from the beginning of the period 4.

Specifically, in the period 4, the duty setting register 21R supplies, to the comparator 23R, (i) a High instruction signal at the end of the sub period 4-2, which is the first half of the period 4, and (ii) a Low instruction signal at the end of the sub period 4-4. The comparator 23R obtains the counted number of clocks from the counter circuit 22R. The comparator 23R outputs High after obtaining {(4096×3)+(4096/4)×2}=14336 counts, and outputs Low after obtaining {(4096×3)+(4096/4)×4}=16384 counts.

The PWM B1 signal output shows a PWM signal output at a duty of 25%. Therefore, 25% of the PWM B1 signal output is High in each of the periods 1 to 4. That is, in the periods 1 to 4, High is outputted for a period equivalent to 4096×0.25=1024 counts.

According to the PWM B1 signal output, each of the periods 1 to 4 is further divided into eight sub periods.

Eight sub periods, into which the period 1 has been divided, from the first sub period to the last sub period, are set to be a sub period 1 (i), 1 (ii), 1 (iii) 1 (viii), respectively. Eight sub periods, into which the period 2 has been divided, from the first sub period to the last sub period, are set to be a sub period 2 (i), 2 (ii), 2 (iii) 2 (viii), respectively. Eight sub periods, into which the period 3 has been divided, from the first sub period to the last sub period, are set to be a sub period 3 (i), 3 (ii), 3 (iii) . . . , 3 (viii), respectively. Eight sub periods, into which the period 4 has been divided, from the first sub period to the last sub period, are set to be a sub period 4 (i), 4 (ii), 4 (iii) . . . , 4 (viii), respectively.

In the period 1, the duty setting register 21R supplies, to the comparator 23R, a High instruction signal at the first count and a Low instruction signal at the end of the sub period 1 (iv). Namely, in the period 1, the comparator 23R outputs High from the beginning of the sub period 1 (i) (i.e., the beginning of one (1) sub frame), and the counter circuit 22R counts the number of clocks of the clock signal GsClk and supplies the counted number of clocks to the comparator 23R. The comparator 23R obtains the counted number of clocks from the counter circuit 22R, and outputs Low after obtaining 1024 (=(4096/8)×2) counts.

According to this, in the period 1, High is outputted in the periods 1 (i) and 1 (ii), which are the first two periods, whereas Low is outputted in the periods 1 (iii) to 1 (viii), which are the latter six periods.

In the period 2, the duty setting register 21B supplies, to the comparator 23B, a High/Low instruction signal which is later than that in the period 1 by three sub periods (periods equivalent to the sub periods 2 (i) to 2 (iii)).

In the period 2, the duty setting register 21B supplies, to the comparator 23B, a High instruction signal at the end of the sub period 2 (iii) and a Low instruction signal at the end of the sub period 2 (v). The comparator 23B obtains the counted number of clocks from the counter circuit 22R. The comparator 23B outputs High after obtaining (4096+(4096/8)×3)=5632 counts, and outputs. Low output after obtaining (4096+(4096/8)×5)=6656 counts.

As described earlier, in the period 2, the PWM B1 signal outputs (1) Low in the sub periods 2 (i) to 2 (iii), which are the respective first to third sub periods, and in the sub periods 2 (vi) to 2 (viii), which are the respective sixth to last sub periods, and (II) High in the sub periods 2 (iv) and 2 (v), which are the respective middle two sub periods.

In the period 3, as in the case of the period 2, the duty setting register 21B supplies, to the comparator 23B, a High/Low instruction signal which is later than that in the period 1 by three sub periods (periods equivalent to the sub periods 3 (i) to 3 (iii)).

In the period 3, the duty setting register 21B supplies, to the comparator 23B, a High instruction signal at the end of the sub period 3 (iii) and a Low instruction signal at the end of the sub period 3 (v). The comparator 23B obtains the counted number of clocks from the counter circuit 22B. The comparator 23B outputs High after obtaining {(4096×2)+(4096/8)×3)}=9728 counts, and outputs Low after obtaining {(4096×2)+(4096/8)×5)}=10752 counts.

As described earlier, in the period 3, the PWM B1 signal outputs (1) Low in the sub periods 3 (i) to 3 (iii), which are the respective first to third sub periods, and in the sub periods 3 (vi) to 3 (viii), which are the respective sixth to last sub periods, and (II) High in the sub periods 3 (iv) and 3 (v), which are the respective middle two sub periods.

In the period 4, it is only necessary that the LED 5B turn off (Low be outputted) for a period equivalent to the number of clocks (3072) which is obtained by subtracting a light emitting period (a period of a High output) from the number of clocks in the period 4 (4096), and then the LED 5B turn on (High be outputted) for a period equivalent to the given number of clocks.

That is, in the period 4, the duty setting register 21B supplies, to the comparator 23B, a High/Low instruction signal which is later than that in the period 1 by six sub periods (periods equivalent to the sub periods 4 (i) to 4 (vi)).

In the period 4, the duty setting register 21B supplies, to the comparator 23B, (i) a High instruction signal at the end of the sub period 4 (vi), and (ii) a Low instruction signal at the end of the sub period 4 (viii). The comparator 23B obtains the counted number of clocks from the counter circuit 22B. The comparator 23B outputs High after obtaining {(4096×3)+(4096/8)×6)}=15360 counts, and outputs Low after obtaining {(4096×3)+(4096/8)×8)}=16384 counts.

As described earlier, in the period 4, the PWM B1 signal outputs (1) Low in the periods 4 (i) to 4 (vi), which are the respective first to sixth periods, and (II) High in the periods 4 (vii) and 4 (viii), which are the latter two periods.

As described above, according to the PWM R1 signal output and the PWM B1 signal output, the LED 5R and the LED 5 B turn on at the beginning and the end of one (1) sub frame. For the middle periods 2 and 3, the LED 5R and the LED 5B turn on in a vicinity of a center of each of the periods.

Since timings at which the PWM G signal, the PW R1 signal, and the PWM B1 signal output High overlap each other for each of the periods, the LED 5G, the LED 5R, and the LED 5B can emit light while overlapping with each other for each of the periods.

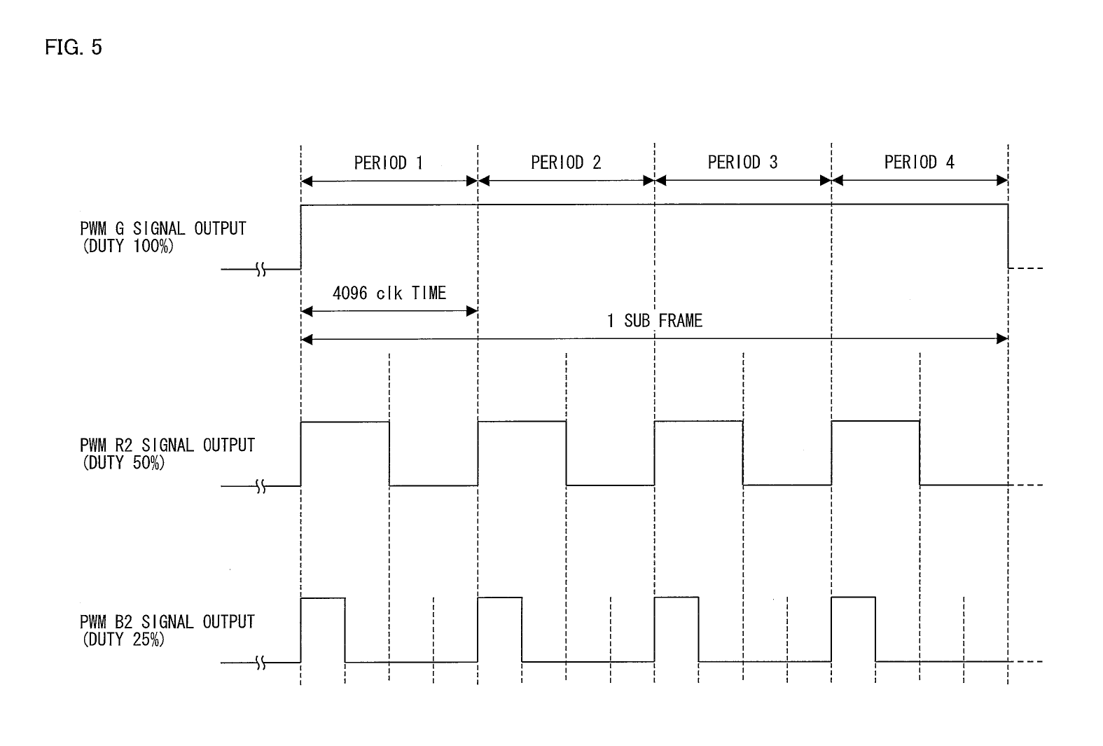

FIG. 5 shows how PWM signals which have respective duties of 100%, 50%, and 25% are generated when timings of a High output are set to coincide with each other so that High is outputted at the beginning of each of sub periods.

According to the PWM R2 signal output in FIG. 5, each of the periods 1 to 4 is further divided into two sub periods. In the first two sub periods of the two sub periods into which the each of the periods 1 to 4 has been divided, High is outputted, whereas Low is outputted in the latter two sub periods. Namely, the PWM R2 signal outputs High at the beginning of each of the periods 1 to 4 (the first count, the 4097th count, the 8193th count, and the 12289th count), and starts outputting Low when the latter sub period of each of the periods 1 to 4 comes (after the 2048th count, the 6144th count, the 1024th count, and the 14336th count).

According to the PWM B2 signal output in the FIG. 5, each of the periods 1 to 4 is further divided into four sub periods. In the first two sub periods of the four sub periods into which the each of the periods 1 to 4 has been divided, High is outputted, whereas Low is outputted in the other three sub periods. Namely, the PWM B2 signal outputs High at the beginning of each of the periods 1 to 4 (the first count, the 4097th count, the 8193th count, and the 12289th count). After 4096/4=1024 counts, the PWM B2 signal starts outputting Low when the second sub period of each of the periods 1 to 4 comes (after the 1024th count, the 5120th count, the 9216th count, and the 13312th count).

As described earlier, the PWM R2 signal output and the PWM B2 signal output cause the LED 5R and LED 5B to turn on simultaneously at the beginning of the each of the periods 1 to 4.

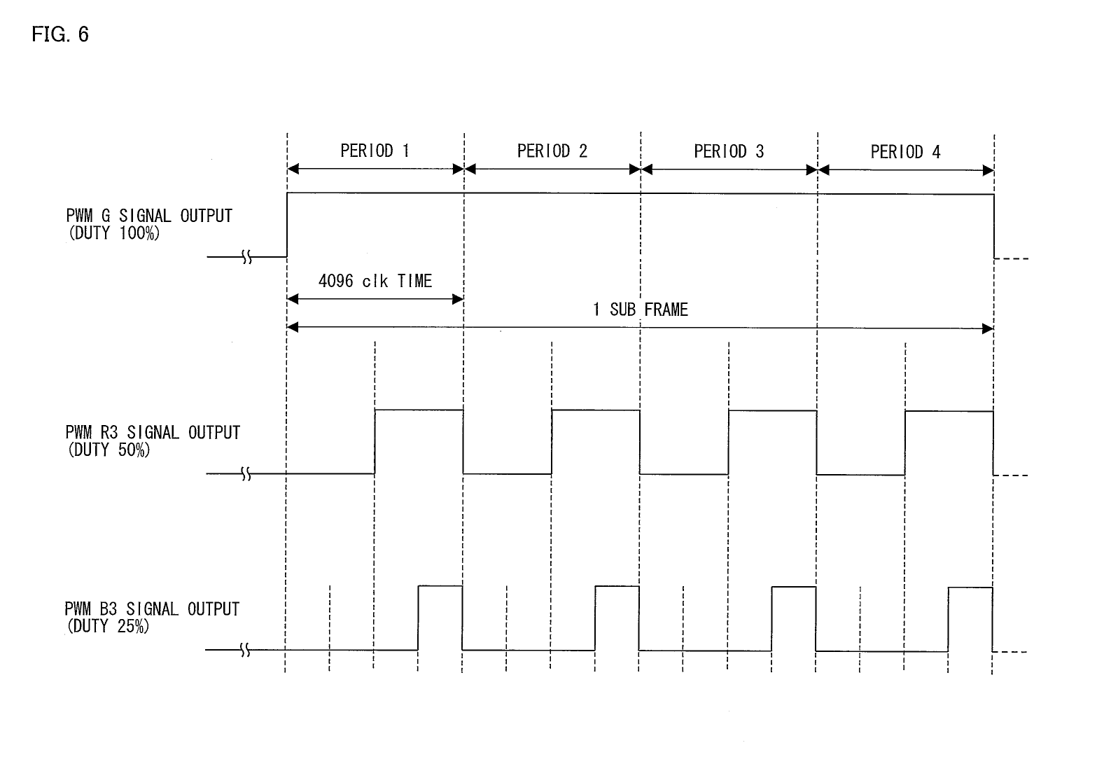

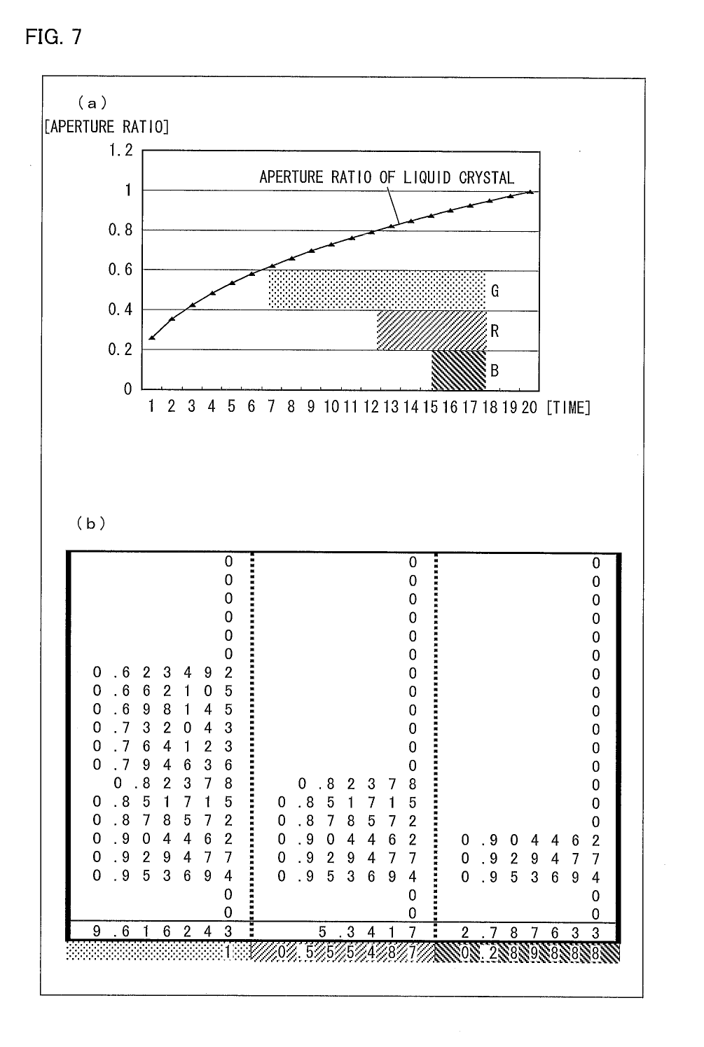

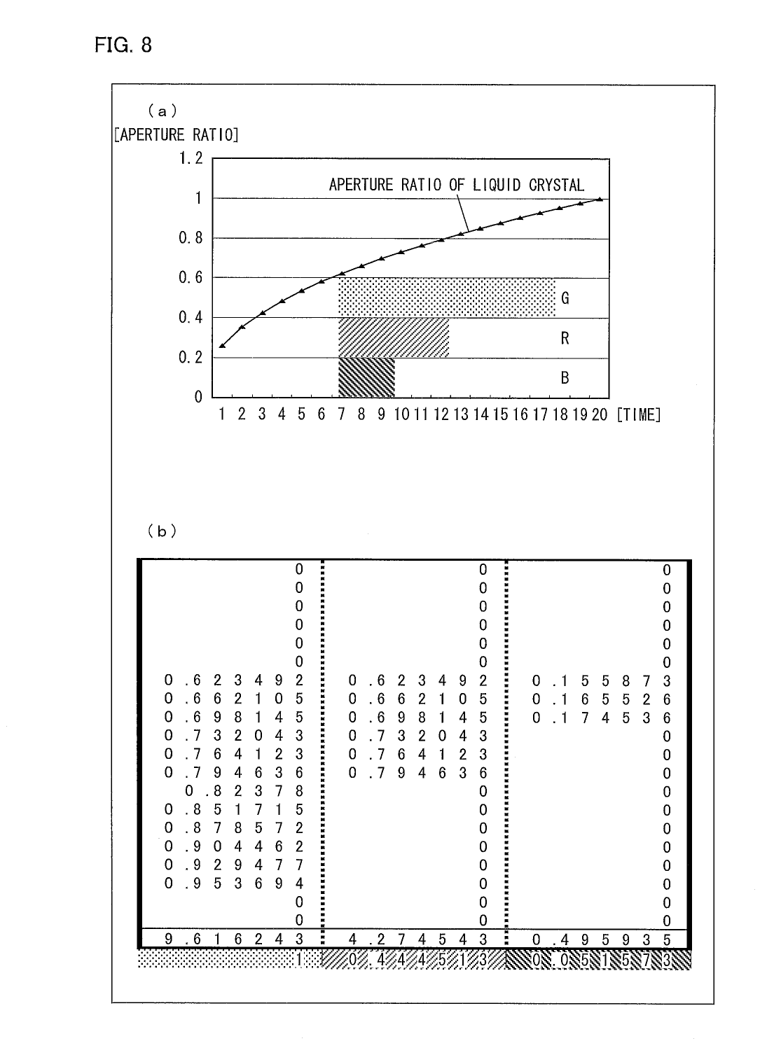

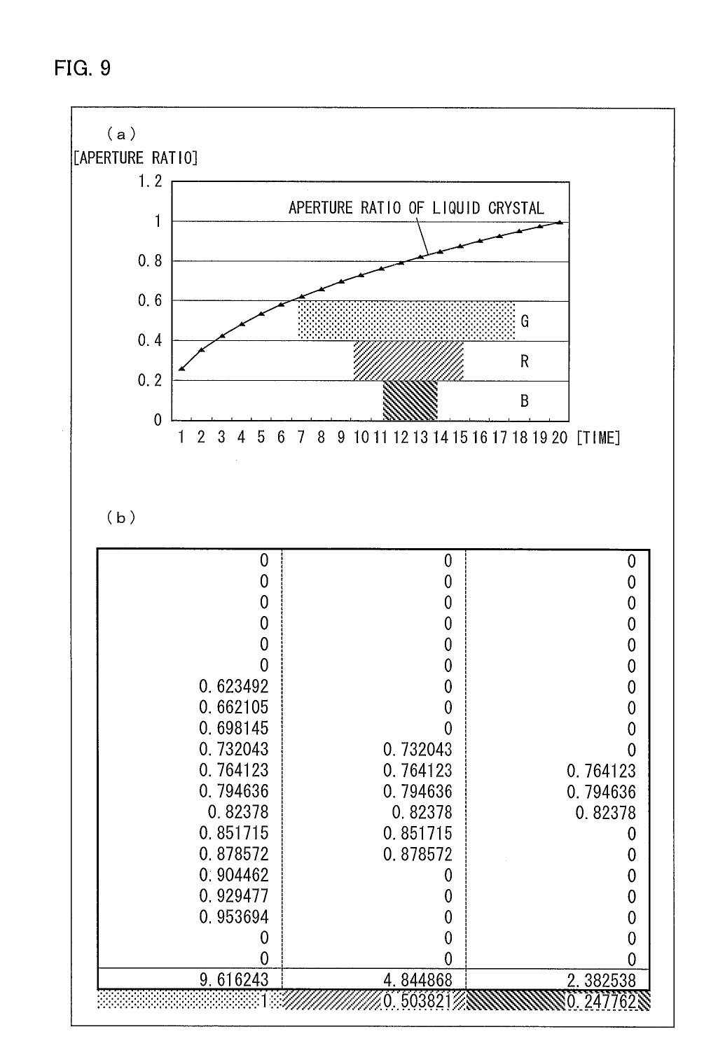

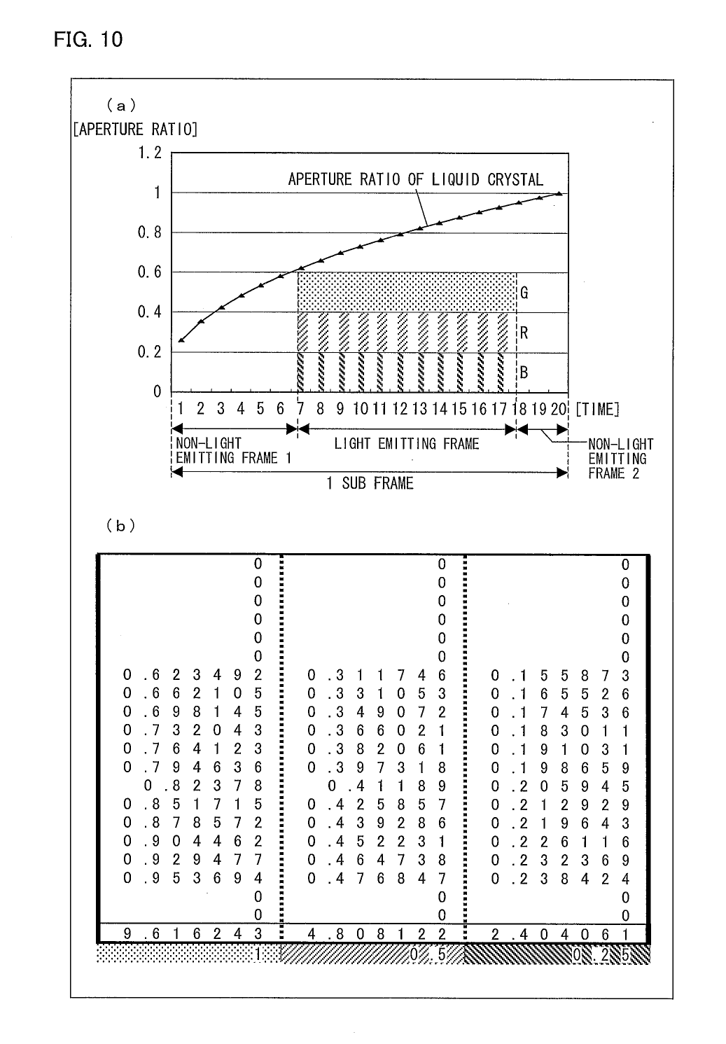

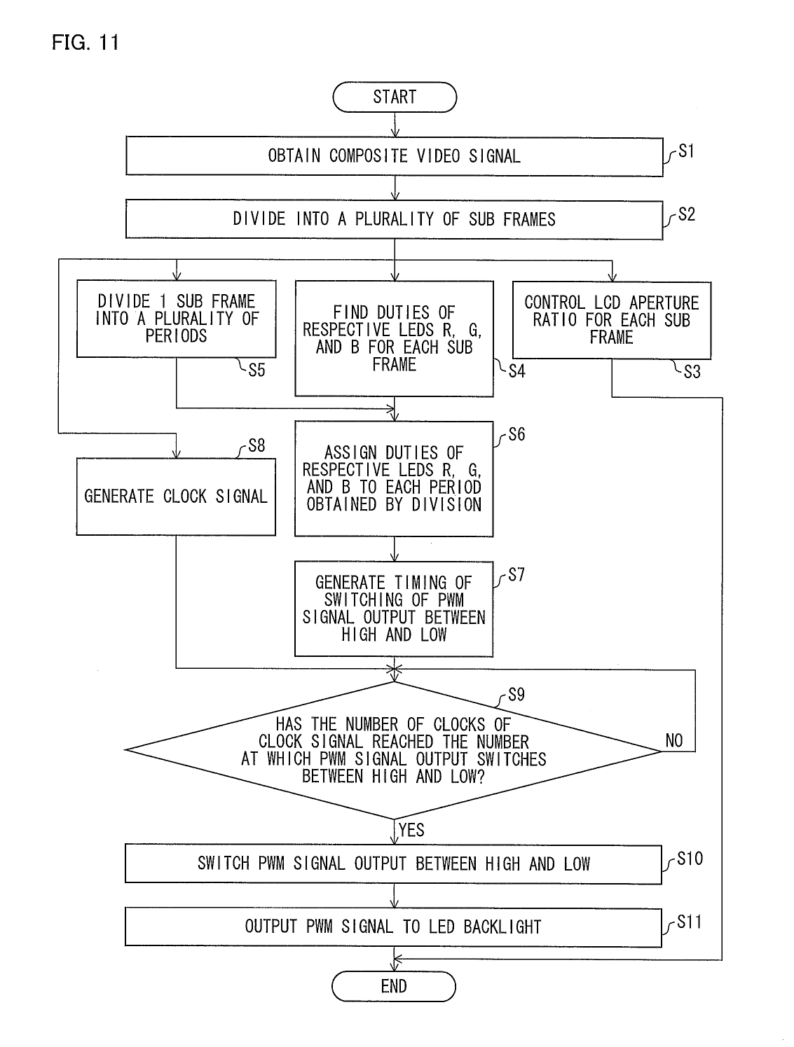

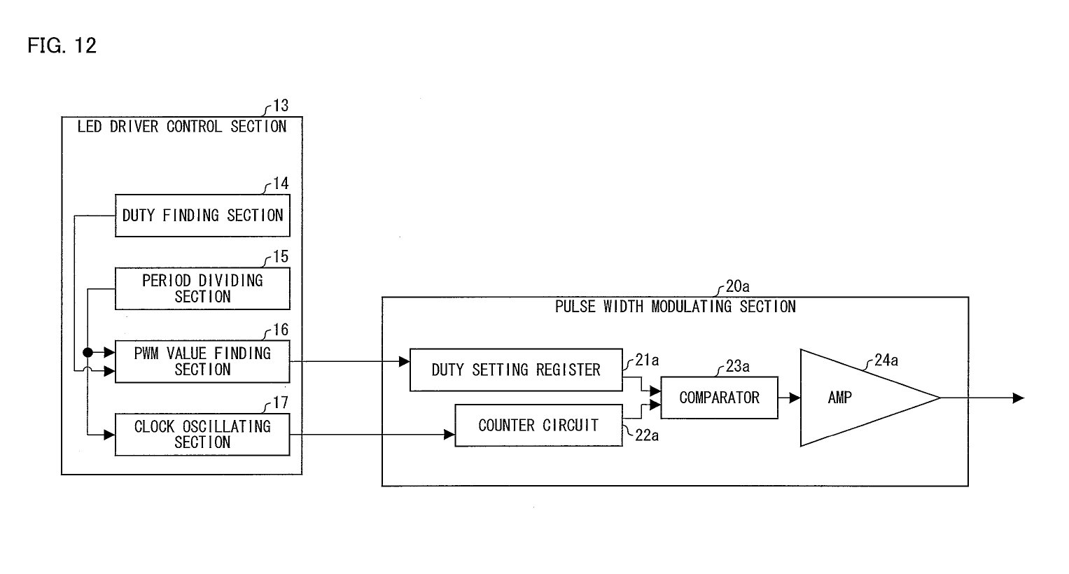

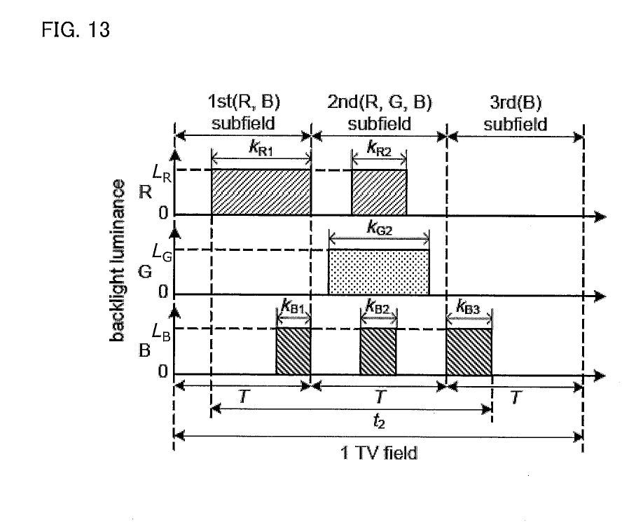

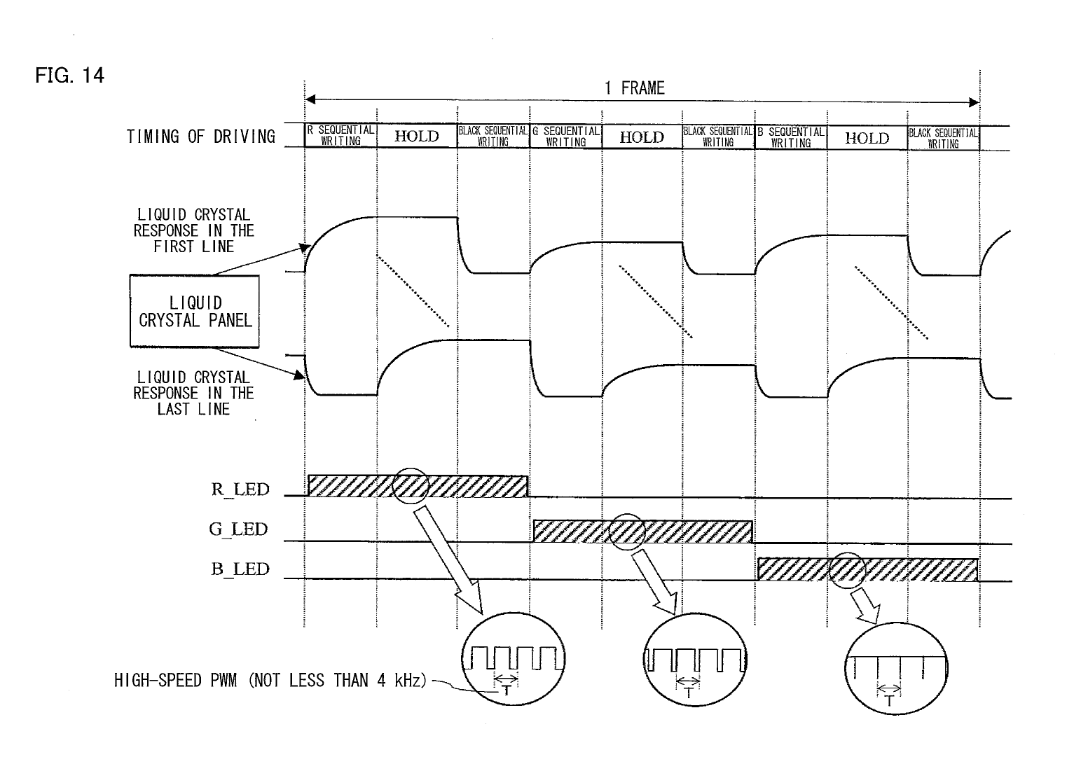

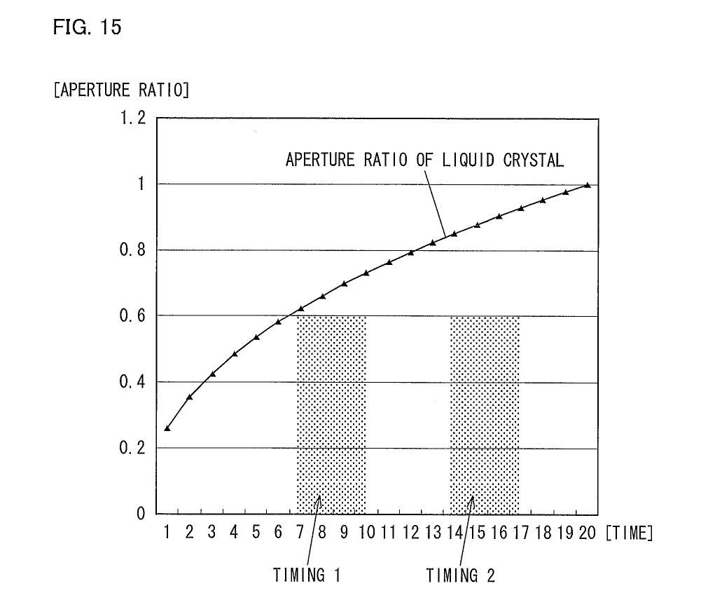

FIG. 6 shows how PWM signals which have respective duties of 100%, 50%, and 25% are generated when timings of a High output are set to coincide with each other so that High is outputted at the end of each of sub periods.

According to the PWM R3 signal output in the FIG. 6, each of the periods 1 to 4 is further divided into two sub periods. In the first sub period of the two sub periods into which the each of the periods 1 to 4 has been divided, Low is outputted, whereas High is outputted in the latter sub period. Namely, the PWM R3 signal outputs Low at the beginning of each of the periods 1 to 4 (the first count, the 4097th count, the 8193th count, and the 12289th count), and starts outputting High when the latter sub period of each of the periods 1 to 4 comes (after the 2048th count, the 6144th count, the 1024th count, and the 14336th count).

According to the PWM B3 signal output of FIG. 6, each of the periods 1 to 4 is further divided into four sub periods. In the first sub period of the four sub periods into which the each of the periods 1 to 4 has been divided, Low is outputted, whereas High output is outputted in the fourth sub period. Namely, the PWM B3 signal outputs Low at the beginning of each of the periods 1 to 4 (the first count, the 4097th count, the 8193th count, and the 12289th count). After (4096/4)×3=3072 counts, the PWM B3 signal starts outputting High when the fourth sub period of each of the periods 1 to 4 comes (after the 3072th count, the 7168th count, the 11264th count, and the 15360th count).

As described earlier, the PWM R3 signal output and the PWM B3 signal output cause the LED 5R and LED 5B to turn on simultaneously at the end of the each of the periods 1 to 4.

<Luminance Ratio of Light Transmitted Through the Liquid Crystal Panel>

In a state in which each of the LED 5R, the LED 5G, and the LED 5B turned on for an identical period, it has been found that a difference in method of causing the LED 5R, the LED 5G, and the LED 5B to turn on (timing of turning-on of the LED 5R, the LED 5G, and the LED 5B) causes a difference in transmission luminance ratio of light which has been transmitted through an LCD. The following description discusses this with reference to (a) and (b) of FIG. 7 to (a) and (b) of FIG. 10.

According to all methods of turning on LEDs R, G, and B (see (a) and (b) of FIG. 7 to (a) and (b) of FIG. 10), a duty ratio among the LEDs G, R, and B is LED G; 100%:LED R; 25%:LED B; 50%=1.00:0.50:0.25.

(a) of FIG. 7 shows how the LEDs G, R, and B are sequentially turned on by causing the LEDs G, R, and B to turn off at an identical timing without dividing one (1) sub frame into a plurality of periods. (b) of FIG. 7 shows transmission luminances of light which has been transmitted through the LCD in accordance with the method shown in (a) of FIG. 7.

In (a) of FIG. 7, timings at which the LED G, the LED R, and the LED B start turning on are adjusted, so that the LED G, the LED R and the LED B stop turning on (turn off) simultaneously. According to this, the duty ratio among the LEDs G, R, and B is set to be 1.00:0.50:0.25.

(b) of FIG. 7 numerically shows transmission luminances of light which has been transmitted through the LCD for each of G, R, and B. A transmission luminance ratio among G, R, and B is 1.00:0.56:0.29 (obtained by rounding off the third decimal place) (see (b) of FIG. 7). Thus, unlike the duty ratio among the LEDs G, R, and B, the transmission luminances of the LCD are not in accordance with the duty ratio among the LEDs G, R, and B.

(a) of FIG. 8 shows how the LEDs R, G, and B are sequentially turned on by causing the LEDs R, G, and B to start turning on at an identical timing without dividing one (1) sub frame into a plurality of periods. (b) of FIG. 8 shows transmission luminances of light which has been transmitted through the LCD in accordance with the method shown in (a) of FIG. 8.

In (a) of FIG. 8, timings at which the LED G, the LED R, and the LED B start turning on coincide with each other, so that timings at which the LED G, the LED R, and the LED B stop turning on (turn off) are adjusted. According to this, the duty ratio among the LEDs G, R, and B is set to be 1.00:0.50:0.25.

(b) of FIG. 8 numerically shows transmission luminances of light which has been transmitted through the LCD for each of G, R, and B. A transmission luminance ratio among G, R, and B is 1.00:0.44:0.05 (obtained by rounding off the third decimal place) (see (b) of FIG. 8). Thus, unlike the duty ratio among the LEDs G, R, and B, the transmission luminances of the LCD are not in accordance with the duty ratio among the LEDs G, R, and B.

(a) of FIG. 9 shows how the LEDs G, R, and B are sequentially turned on by causing centers of respective light emitting periods of the respective LEDs G, R, and B to coincide with each other without dividing one (1) sub frame into a plurality of periods. (b) of FIG. 9 shows transmission luminances of light which has been transmitted through the LCD in accordance with the method shown in (a) of FIG. 9.

In (a) of FIG. 9, timings at which the LED G, the LED R, and the LED B start turning on and stop turning on (turn off) are controlled, so that the centers of the respective light emitting periods of the respective LEDs G, R, and B coincide with each other. According to this, the duty ratio among the LEDs G, R, and B is set to be 1.00:0.50:0.25.

(b) of FIG. 9 numerically shows transmission luminances of light which has been transmitted through the LCD for each of G, R, and B. A transmission luminance ratio among G, R, and B is 1.000:0.504:0.248 (obtained by rounding off the fourth decimal place) (see (b) of FIG. 9). Thus, unlike the duty ratio among the LEDs G, R, and B, the transmission luminances of the LCD are not in accordance with the duty ratio among the LEDs G, R, and B.

(a) of FIG. 10 shows a method of turning on the LEDs of the liquid crystal display device 101 in accordance with the present embodiment.

(a) of FIG. 10 shows a method of turning on the LEDs 5R, 5G, and 5B for each of a plurality of periods into which one (1) sub frame has been divided. (b) of FIG. 10 shows transmission luminances of light which has been transmitted through the LCD in accordance with the method shown in (a) of FIG. 10.

In (a) of FIG. 10, timings at which LED 5G, LED 5R, and LED 5B start turning on coincide with each other. According to this, the duty ratio among the LEDs 5G, 5R, and 5B is set to be 1.00:0.50:0.25.

(b) of FIG. 10 numerically shows transmission luminances of light which has been transmitted through the LCD for each of G, R, and B. A transmission luminance ratio among G, R, and B is 1.00:0.50:0.25 (obtained by rounding off the third decimal place) (see (b) of FIG. 10). The transmission luminance ratio is thus identical to the duty ratio among the LEDs 5G, 5R, and 5B. That is, the transmission luminances of the LCD are in accordance with the duty ratio among the LEDs 5G, 5R, and 5B.

As described earlier, the turning-on method of the liquid crystal display device 101 allows the transmission luminance ratio among RGB having transmitted through the LCD to be identical to a luminance ratio set by light control by PWM. This improves an accuracy with which color reproduction is carried out.

Even if an aperture ratio of the liquid crystal panel varies in accordance with responsiveness of a liquid crystal in one (1) sub frame, division of a period in which the LEDs 5R, 5G, and 5B emit light in one (1) sub frame into a plurality of periods allows a reduction in variation between (i) a predetermined luminance ratio among the LEDs 5R, 5G, and 5B for displaying a color image and (ii) a transmission luminance ratio among the LEDs 5R, 5G, and 5B which have been transmitted through the liquid crystal panel 4.

In addition, according to the turning-on method shown in (a) of FIG. 10, for each of the plurality of periods, the LEDs 5R, 5G, and 5B emit light while overlapping with each other. Therefore, colors of light emitted from the respective LEDs 5R, 5G, and 5B are mixed for each of periods in one (1) sub frame. Therefore, even if an aperture ratio of the liquid crystal panel 4 varies in one (1) sub frame, it is possible to reduce a variation between a predetermined luminance ratio and a transmission luminance ratio. Furthermore, even in another sub frame, it is also possible to reduce a variation between a predetermined luminance ratio and a transmission luminance ratio.

As described earlier, the liquid crystal display device 101 allows a reduction in variation between a preset luminance ratio and a transmission luminance ratio, so that a deterioration in display quality can be prevented.

Moreover, one (1) sub frame may be divided into (i) a light emitting frame (period) in which LEDs 5R, 5G, and 5B emit light and a non-light emitting frame (period) in which a black image is displayed (see (a) of FIG. 10). In the example of (a) of FIG. 10, a non-light emitting frame 1 followed by a light-emitting frame and a non-light emitting frame 2 following the light-emitting frame are provided in one (1) sub frame.

Namely, in a period of the plurality of periods into which one (1) sub frame has been divided, the period being adjacent to another at least one frame, the pulse width modulating section 20 may generate a PWM signal so as to turn off all of the LEDs 5G, 5R, and 5B.

According to this, a black image is displayed in each of the non-light emitting frame 1 and the non-light emitting frame 2 in one (1) sub frame, the non-light emitting frame 1 and the non-light emitting frame 2 each being adjacent to another sub frame. This can prevent, between sub frames, mixing of colors of light which has been transmitted through the liquid crystal panel 4, so that a display quality can be improved.

Moreover, assume that area active drive control is carried out with respect to the LEDs 5G, 5R, and 5B. In a case where the liquid crystal 4 is scanned for displaying an image and each of the LEDs 5G, 5R, and 5B are scanned, a difference in responsiveness in a liquid crystal panel 4 can be reduced. Therefore, in order to display a color image in one (1) frame, it is possible to reduce a time required for turning on the LEDs 5G, 5R, and 5B.

According to this, for example, unlike the Patent Literature 2, it is unnecessary to cause an LED to continuously emit light in all periods of one (1) sub frame so as to display a color image. Therefore, all of the LEDs 5G, 5R, and 5B can be turned off without fail in a period of a plurality of periods of one (1) sub frame, the period being adjacent to another sub frame.

Meanwhile, if a backlight emits light for an entire sub field (or nearly entire sub field) as described in, for example, the display method of the Patent Literature 2 (see FIG. 13), a color to be emitted subsequently and a color being emitted currently mix. This causes a color unevenness.

As described above, the liquid crystal display device 101 can more securely prevent, between frames, mixing of colors of light transmitted through a liquid crystal panel 4, so that a display quality can be improved.

Note that, although the present embodiment has discussed an example of a color display by use of three primary colors of R, G, and B, the present invention is not limited to the three primary colors of R, G, and B. Alternatively, the present invention may employ a combination of colors for performing a different color display. For example, also in a case where Y (yellow), C (cyan), and M (magenta) are used for performing a color display and a similar process is carried out, a similar effect can be achieved.

<Flowchart>

Next, the following description discusses, with reference to FIG. 11, how a process is carried out in the liquid crystal display device 101.

FIG. 11 is a flowchart showing how a process is carried out in the liquid crystal display device 101.

Firstly, the video signal receiving section 1 obtains an externally inputted composite video signal (step S1), and supplies the obtained composite video signal to the video signal processing section 2.

The video signal processing section 2 which has obtained the composite signal from the video signal receiving section 1 divides one (1) frame of the obtained composite signal into a plurality of sub frames (step S2).

Then, the video signal processing section 2 supplies, to the liquid crystal panel controller 3, an RGB data signal and a sync signal for the liquid crystal panel 4 for each of the plurality of sub frames obtained by the division of the one (1) frame. The video signal processing section 2 also supplies, to the LED controller 10, an RGB data signal and a sync signal for turning on the LED backlight 5 for the each of the plurality of sub frames.

The liquid panel controller 3 which has obtained, from the video signal processing section 3, the RGB data signal and the sync signal for the liquid crystal panel 4 for the each of the plurality of sub frames finds an aperture ratio of a liquid crystal (LCD aperture ratio) for the each of the plurality of sub frames in accordance with the RGB data signal and the sync signal for the liquid crystal panel 4 for the each of the plurality of sub frames. Then, in accordance with the LCD aperture ratio thus found, the liquid panel controller 3 controls an aperture ratio of the liquid crystal panel 4 for the each of the plurality of sub frames by controlling a source driver (not illustrated) and a gate driver (not illustrated) (step S3).

A duty finding section 14 which has obtained the RGB data signal and the sync signal for turning on the LED backlight 5 to emit light, the RGB data signal and the sync signal each having been supplied from the video signal processing section 2 to the LED controller 10 finds duties of the respective LEDs 5R, 5G, and 5B for the each of the plurality of sub frames for carrying out area active drive (step S4). The duty finding section 14 supplies the found duties of the respective LED 5R, 5G, and 5B to the PWM value finding section 16.

After the RGB data signal and the sync signal for turning on the LED backlight 5 have been supplied from the video signal processing section 2 to the LED controller 10, the period dividing section 15 further divides one (1) sub frame into a plurality of periods (step S5). The period dividing section 15 supplies, to each of the PWM value finding section 16 and the clock oscillating section 17, the number of periods into which one (1) frame has been divided.

The PWM value finding section 16 which has obtained (i) from the duty finding section 14, the duties of the respective LEDs 5R, 5G, and 5B for the each of the plurality of sub frame and (ii) from the period dividing section 15, the number of periods into which one (1) frame has been divided assigns the duties of the respective LEDs 5R, 5G, and 5B to each of the periods obtained by the division of one (1) sub frame (step S6).

Then, the PWM value finding section 16 supplies, to each duty setting register 21 as a PWM value, the duties of the respective LEDs 5R, 5G, and 5B which have been assigned to the each of the periods.

The duty setting register 21 which has obtained the PWM value from the PWM value finding section 16 generates a High/Low instruction signal which shows a timing of switching of a PWM signal output between High and Low for the each of the periods (step S7). The duty setting register 21 supplies the generated High/Low instruction signal to the comparator 23. The timing of the switching of the PWM signal output between High and Low is arranged so that for each of the plurality of periods into which the period dividing section 15 has divided the frame, the LEDs 5R, 5G, and 5B emit light while overlapping with each other.

The clock oscillating section 17 generates a clock signal at a frequency obtained by multiplying a predetermined frequency of one (1) sub frame by the number of periods into which one (1) sub frame has been divided, the number having been supplied from the period dividing section 15 (step S8).

The clock oscillating section 17 supplies the generated clock signal to each counter circuit 22 as a clock signal GsClk. The counter circuit 22 counts clocks of the clock signal GsClk supplied from the clock oscillating section 17, and supplies the number of clocks thus counted to the comparator 23.

The comparator 23 obtains (i) the High/Low instruction signal supplied from the duty setting register 21 and (ii) the number of clocks of the clock signal GsClk, the number having been supplied from the counter circuit 22. When the number of clocks obtained from the counter circuit 22 reaches the number indicated by the High/Low instruction signal obtained from the duty setting register 21, the comparator 23 recognizes this moment as a timing of switching of the PWM signal output between High and Low (YES at step S9), causes the PWM signal output to switch between High and Low (step S10), and supplies the PWM signal to the AMP 24.

The AMP 24 amplifies the PWM signal whose output is High or Low and which has been supplied from the comparator 23, and supplies the amplified PWM signal to the LED backlight 5 via the process control section 11 (step S11). According to this, the LEDs 5R, 5G, and 5B emit light while overlapping with each other for each of the periods obtained by the division at the step S5.

As described earlier, in the step S5, the period dividing section 15 further divides, into a plurality of periods, each one (1) of sub frames into which one (1) frame has been divided. Note that steps S7, S9, and S10 are process steps carried out by the pulse width modulating section 20.

At the steps S7, S9, and S10, the pulse width modulating section 20, for each of the periods obtained by dividing one (1) sub frame at the step S5, generates a PWM signal for causing each of the LEDs 5R, 5G, and 5B to emit light so that the LEDs 5R, 5G, and 5B emit light while overlapping with each other.

According to this, even if a difference in responsiveness of a liquid crystal in one (1) sub frame causes a variation an aperture ratio of the liquid crystal panel 4, division of a period in which the LEDs 5R, 5G, and 5B emit light in one (1) sub frame into a plurality of periods allows a reduction in variation between (i) a predetermined luminance ratio among the LEDs 5R, 5G, and 5B for displaying a color image and (ii) a transmission luminance ratio among R, G, and B light having been actually transmitted through the liquid crystal panel 4.

Moreover, the pulse width modulating section 20 generates a PWM signal for causing each LEDs 5R, 5G, and 5B to emit light so that the LEDs 5R, 5G, and 5B emit light while overlapping with each other for each of the plurality of periods obtained by the division by the period dividing section 15. According to this, colors of light emitted from the respective LEDs 5R, 5G, and 5B are mixed for each of the plurality of periods of one (1) sub frame. Therefore, even if an aperture ratio of the liquid crystal panel 4 varies in a sub frame, a variation between a predetermined luminance ratio and a transmission luminance ratio can be reduced.

Furthermore, colors of light emitted from the respective LEDs 5R, 5G, and 5B are mixed for each of the plurality of periods of one (1) sub frame. Therefore, a variation between a predetermined luminance ratio and a transmission luminance ratio can be reduced also in a different sub frame.

As described earlier, the arrangement of the liquid crystal display device 101 allows a reduction in variation between a predetermined luminance ratio and a transmission luminance ratio, so that a deterioration in display quality can be prevented.

The present invention is not limited to the description of the embodiments above, but may be altered by a skilled person within the scope of the claims. An embodiment based on a proper combination of technical means disclosed in different embodiments is encompassed in the technical scope of the present invention.

As described earlier, a liquid crystal display device of the present invention including a liquid crystal panel and a backlight which is provided with a plurality of light sources that emit light of different colors from a backside of the liquid crystal panel, the liquid crystal display device, in accordance with a frame of a video signal supplied thereto, (i) displaying a color image by controlling an aperture ratio of the liquid crystal panel and luminances of the respective plurality of light sources, and (ii) controlling the luminances of the respective plurality of light sources by pulse width modulation, the liquid crystal display device includes: period dividing means for dividing a frame of the video signal into a plurality of periods; and a pulse width modulating section which generates a pulse signal for causing each of the plurality of light sources to emit light so that for each of the plurality of periods into which the period dividing means has divided the frame, the plurality of light sources emit light while overlapping with each other.

In order to attain the object, a liquid crystal display method of the present invention in which in accordance with a video signal supplied to a liquid crystal display device including a liquid crystal panel and a backlight which is provided with a plurality of light sources that emit light of different colors from a backside of the liquid crystal panel, (i) a color image is displayed by controlling an aperture ratio of the liquid crystal panel and luminances of the respective plurality of light sources, and (ii) the luminances of the respective plurality of light sources are controlled by pulse width modulation, the liquid crystal display method includes the steps of: (a) dividing a frame of the video signal into a plurality of periods; and (b) generating a pulse signal for causing each of the plurality of light sources to emit light so that for each of the plurality of periods into which the frame has been divided in the step (a), the plurality of light sources emit light while overlapping with each other.

According to the arrangement mentioned above, the period dividing means divides a frame into a plurality of periods. The pulse width modulating section generates a pulse signal for causing each of the plurality of light sources to emit light for each of the periods into which the frame has been divided by the dividing means. As described earlier, even if an aperture ratio of the liquid crystal panel varies in the frame, division, into a plurality of periods, of a period in which a light source emits light in one (1) frame can reduce a variation between (i) a ratio (predetermined luminance ratio) among luminances (predetermined luminances) of respective light sources for displaying a color image and (ii) a ratio (transmission luminance ratio) among luminances (transmission luminances) of respective light sources which have been actually transmitted through the liquid crystal panel 4.

According to the arrangement mentioned above, the pulse width modulating section generates a pulse signal for causing each of the plurality of light sources to emit light so that for each of the plurality of periods into which the period dividing means has divided the frame, the plurality of light sources emit light while overlapping with each other. According to this, colors of light emitted from the respective plurality of light sources are mixed for each of the plurality of periods of the frame. Therefore, even if an aperture ratio of the liquid crystal panel varies in the frame, a variation between a predetermined luminance ratio and transmission luminance ratio can be reduced.

Furthermore, according to the arrangement mentioned above, colors of light emitted from the respective light sources are mixed for each of the plurality of periods of the frame. Therefore, a variation between a predetermined luminance ratio and a transmission luminance ratio can be reduced also in a different frame.

As described earlier, the arrangement mentioned above allows a reduction in variation between a predetermined luminance ratio and a transmission luminance ratio, so that a deterioration in display quality can be prevented.

It is preferable that in a period of the plurality of periods into which the frame has been divided, the period being adjacent to another at least one frame, the pulse width modulating section generate the pulse signal so as to turn off all the plurality of light sources.

According to the arrangement mentioned above, a black image is displayed in a period of the plurality of periods into which the frame has been divided, the period being adjacent to another at least one frame. This enables prevention, between frames, of mixing of colors of light transmitted through the liquid crystal panel, so that a display quality can be improved.

It is preferable that the plurality of light sources of the backlight be controlled to emit light separately in each region.

The arrangement allows a reduction in difference in responsiveness in the liquid crystal panel, the difference occurring while an image is being displayed in the frame. Therefore, in order to display a color image, it is possible to reduce a time required for turning on the plurality of light sources. According to this, it is unnecessary to cause a light source to emit light continuously in all the plurality of periods of the frame. Therefore, all of the plurality of light sources can be turned off more securely in a period of the plurality of periods of the frame, the period being adjacent to another at least one frame.

Accordingly, it is more securely possible to prevent, between frames, mixing of colors of light transmitted through the liquid crystal panel, so that a display quality can be improved.

It is preferable that the different colors of the light emitted from the plurality of light sources be red, green and blue provided that the different colors are used for a color display. Alternatively, it is preferable that the different colors of the light emitted from the plurality of light sources be yellow, cyan, and magenta. According to the arrangement, the light emitted from the respective plurality of light sources enables a color image to be displayed.

It is preferable that the plurality of sources be light emitting diodes (LEDs). According to this, a luminance can be controlled by pulse width modulation.

The present invention is particularly applicable to a liquid crystal display device which carries out a color display by use of a field sequential method.

1. A liquid crystal display device including a liquid crystal panel and a backlight which is provided with a plurality of light sources that emit light of different colors from a backside of the liquid crystal panel,
the liquid crystal display device, in accordance with a video signal supplied thereto, (i) displaying a color image by controlling an aperture ratio of the liquid crystal panel and luminances of the respective plurality of light sources, and (ii) controlling the luminances of the respective plurality of light sources by pulse width modulation,
said liquid crystal display device comprising:
period dividing means for dividing a frame of the video signal into a plurality of periods; and
a pulse width modulating section which generates a pulse signal for causing each of the plurality of light sources to emit light so that for each of the plurality of periods into which the period dividing means has divided the frame, the plurality of light sources emit light while overlapping with each other.

2. The liquid crystal display device as set forth in claim 1, wherein in a period of the plurality of periods into which the frame has been divided, the period being adjacent to another at least one frame, the pulse width modulating section generates the pulse signal so as to turn off all the plurality of light sources.

3. The liquid crystal display device as set forth in claim 1, wherein the plurality of light sources of the backlight are controlled to emit light separately for each region.

4. The liquid crystal display device as set forth in claim 1, wherein the different colors of the light emitted from the plurality of light sources are red, green, and blue.

5. The liquid crystal display device as set forth in claim 1, wherein the different colors of the light emitted from the plurality of light sources are yellow, cyan, and magenta.

6. The liquid crystal display device as set forth in claim 1, wherein the plurality of light sources are light emitting diodes.

7. A liquid crystal display method in which in accordance with a video signal supplied to a liquid crystal display device including a liquid crystal panel and a backlight which is provided with a plurality of light sources that emit light of different colors from a backside of the liquid crystal panel, (i) a color image is displayed by controlling an aperture ratio of the liquid crystal panel and luminances of the respective plurality of light sources, and (ii) the luminances of the respective plurality of light sources are controlled by pulse width modulation,
said liquid crystal display method comprising the steps of:
(a) dividing a frame of the video signal into a plurality of periods; and
(b) generating a pulse signal for causing each of the plurality of light sources to emit light so that for each of the plurality of periods into which the frame has been divided in the step (a), the plurality of light sources emit light while overlapping with each other.
